(19) United States
(12) Patent Application Publication
(10) Pub. No.: US 2017/0337647 A1
(43) Pub. Date: Nov. 23, 2017

(54) METHODS AND SYSTEMS FOR PERFORMING PEER TO PEER REAL ESTATE TRANSACTIONS

(71) Applicant: GREGORY VAYNSHTEYN, HEWLETT HARBOR, NY (US)

(72) Inventor: GREGORY VAYNSHTEYN, HEWLETT HARBOR, NY (US)

(73) Assignee: LOTWOLF, INC., Hewlett Harbor, NY (US)

(21) Appl. No.: 15/159,993

(22) Filed: May 20, 2016

(51) Int. Cl. G06Q 50/16; G06Q 50/18

(52) U.S. Cl. CPC G06Q 50/16; G06Q 50/18

(57) ABSTRACT

Methods and systems for facilitating peer to peer real estate transactions are provided. One method includes the receiving and storing of data relating to offers to sell, buy or lease a property, compiling a list of potential matches between sellers and buyers, and landlords and tenants, connecting parties based on the financial status of the buyer or tenant, providing a database of real estate related professionals and providing a means for connecting interested parties. The system provides the means for distributed computer network to enable the method to be carried out.

### BACKGROUND OF THE INVENTION

Real estate transactions are a complex affair and the agreement for each transaction can vary drastically. Real estate transactions can involve the sale and purchase of a property, transferring the entire rights permanently, but may also involve a temporary agreement between a lessor and lessee (landlord and tenant), in which the rights conferred to the tenant are for a set period of time. The categories of real estate transactions can be further broken up into transactions involving residential and commercial properties. The individual nature of each transaction is further compounded by the different needs the seller, buyer, lessor, or lessee have. Thus it may be difficult for a seller to match a buyer, and a lessor with a lessee without widespread access to a number of different listings across a number of locations.

The typical process for a real estate transaction starts with a seller contacting a real estate agent to list the property. The agent will then start the process of analysing the housing market of the local area and inspect the property to set a price. Once a price has been established, the property is placed on the market through a number of different avenues ranging from direct advertisement, open houses, and listing services. Perspective buyers are able to view the property both remotely and through arrangements to visit the property. It is the job of the seller's agent to find perspective buyers and obtain the best possible deal for the seller. The buyer's agent works for the best interests of the buyer, and finds properties that meet the needs of the buyers, whilst trying to obtain the best price. Thus agents are typically biased towards one party. The buyers are then able to place an offer on the property with the aid of an agent. The two agents may then enter into a negotiation to set the terms of a contract, which is acceptable to both buyer and seller.

The acceptance of the sales contract then begins a number of actions to move the transaction into closing. Information on the state of the property is furnished to the buyer from the seller, which can be achieved through an inspection report. The buyer fulfils the necessary financial requirements, including providing earnest money, down payment and obtaining a loan. Whilst agents must perform the necessary legal requirements for the transfer of the property, such as opening escrow and performing title searches, and producing reports.

Additional negotiations may be necessary following the initial sales contract as the property disclosures may unearth a potential issue that would be costly to resolve for the buyer. Once all requirements are fulfilled, however, the process enters into the closing procedures, which involves a final check of the property, and transfer of the deeds and access to the property, officially ending the transaction. This process may be performed without the seller and buyer ever contacting one another directly, and performed solely through interactions between the two agents.

Traditionally, real estate brokers and agents, are used to match sellers and buyers, and lessors and lessees, through access to a listing service such as the Multiple Listing Service (MLS). Brokers and agents work on commission, receiving payment as a percentage of the sale price of the house. The percentage commission requested by a broker or agent can be as high as six percent of final selling price of the property. As such the fees for the use of brokers and agents can be exorbitant and a major burden for the seller. These problems are not limited to the sale of residential real estate but also for commercial properties, and even for the negotiations of the lease agreements for a landlord and tenant in cities. These high fees can be prohibitive to sellers and landlords, as they are commonly the parties that are burdened with the costs.

The wide spread use of internet technology to conduct business has facilitated real estate transactions remotely and allowed potential sellers or buyers to reach a wider audience than previously before. However, online real estate services currently maintain the use of brokers, agents, or other real estate advisors to conduct the search, negotiations and sales of the property which continue to preserve the high cost of real estate transactions.

The complexities associated with real estate transactions discourage many potential sellers and buyers from going through the process without a broker or agent. Additionally, the need to submit documents for example, credit checks and references to each individual seller further burdens potential customers from acting in the absence of a broker or agent. As such there is a need for the ability to perform peer to peer real estate transactions using an integrated and guided manner.

There are many requirements that must be fulfilled to effectively conduct a real estate transaction, such as credit checks. A credit report can be obtained from a credit bureau and is a summary of the applicant's financial status. Key metrics such as previous loans, the timeliness of payments, defaults and bankruptcies are displayed in a credit report, which culminates in a credit score. The credit score is a numerical value assigned to an applicant which summarises their financial trustworthiness. The credit score ranges generally from 300-850, but may vary slightly depending on credit bureau. Buyers require credit checks to help determine the availability of a mortgage and mortgage rate. Sellers can use credit reports to vet potential buyers, ensuring they have the means to obtain a mortgage for the asking price of the property. Landlords are able to use credit reports to determine which tenants to choose and the reliability of a tenant. Thus, there is a need for a system for all participants to efficiently receive the credit information in the context of a real estate transaction.

Other Key functions such as drafting of contracts, home inspections and escrow services are also required to perform a real estate transaction, and finding a trusted provider of these services may be difficult for individuals without prior experience in the real estate field. Additionally, there is a further industry for real estate related services, including interior decorators, contractors, moving companies, and photographers, which may interest sellers, buyers, tenants or landlords. Having easy access to these services would be greatly beneficial to anyone involved in any real estate transaction. The benefits would also extend to the real estate related professionals, due to the direct advertisement to the target audience.

### SUMMARY OF THE INVENTION

The present invention generally pertains to the methods of selling products and services though a peer to peer transaction, and more particularly, to the field of real estate and providing clients with desired services without the requirement of an intermediary broker or agent. There is no longer a need for the use of brokers and agents to act as intermediaries and the sales can be made by sellers and buyers directly.

The invention disclosed is directed to a method and system of facilitating peer to peer sales or lease of real estate property. The current invention meets the need to reduce the cost of real estate transactions through the removal of the real estate broker or agent intermediate by enabling direct interaction of parties interested in entering a real estate transaction. The invention also makes available the ability to access real estate related professionals during a negotiation of a real estate transaction.

The invention in one embodiment is a computer network implemented method for performing real estate transactions in a peer to peer manner comprising of: receiving and storing data, wherein the data is comprised of information related to an offer to sell or lease a real estate property (offer data). Preferably the data received and stored may comprise of, personal information, financial information, nature of transaction, location of property, listing price of property, photographs of property, and structural information on property; receiving and storing data, wherein the data is comprised of information related to an interest in buying or renting a real estate property (buyer data); wherein data received and stored may comprise of: personal information, financial information, nature of transaction, location of a desired property, price range of a desired property, structural information on a desired property, and local information on a desired property; compiling a list, comprising of potential matches between sellers and buyers, or lessors and lessees ranked by the information extracted from offer data and buyer data; connecting a perspective buyer and seller, or lessor and lessee; providing a database of real estate related professionals to seller and buyer, or lessor and lessee; and connecting the interested parties. The methods of connecting interested parties may be through email, mail, instant messages, short messaging service (SMS), or phone calls. In another embodiment, the method may also contain a step which comprises of contacting third parties to confirm accuracy of data input from seller, buyer, tenant, or landlord. In another embodiment, a step comprising of confirming the financial status of a buyer or tenant with a third party prior to connection of two interested parties is also present.

In another embodiment, the method may further comprise of: receiving, extracting, and storing data on the outcome of negotiations; and producing and distributing an initial terms of transaction based on the data extracted from negotiations between a seller and buyer, or lessor and lessee, and any other related party, to said seller and buyer, lessor and lessee, or any other related party. In one embodiment, real estate related professionals from the aforementioned database is used to perform actions resulting from the initial terms of transaction.

The method further comprises of: using the outcomes from the initial terms of transaction for further negotiations; receiving, extracting and storing data on the outcome of any further negotiations; modifying the initial terms of transaction to a refined terms of transaction; and transmitting a refined terms of transaction to both seller and buyer, lessor and lessee, or any other related party. This allows the seller and buyer, lessor and lessee to enter the final phase of negotiation in which a binding contract can be agreed upon based on the refined terms of transaction. Finally, the method may comprise of selecting a legal professional from the database provided to execute a contract based on the refined terms of transaction.

Another aspect of the disclosed invention is a computer network implemented system for enabling peer to peer real estate transaction that is configured to: receive and store data, wherein the data is comprised of information related to an offer to sell or lease a real estate property; receive and store data, wherein the data is comprised of information related to an interest in buying or renting a real estate property; compile a list comprising of potential matches between sellers and buyers, or lessors and lessees based on the information extracted from offer data and buyer data; connects a perspective seller and buyer, or lessor and lessee; provides access to a database of real estate related professionals; and connects any interested parties.

In one embodiment, the system may also be configured to: contact a third party to confirm data input from seller, buyer, lessor or lessee. In another embodiment, the financial information from a buyer or lessee is requested and confirmed. In yet another embodiment, the system is configured to only allow contact between two parties if the financial information of a buyer or lessee meets a minimum requirement set by seller or lessor. In a further embodiment, the system may be further configured to store a set of terms of transaction between a seller and buyer, or lessor and lessee; and able to transmit the terms of transaction to respective parties.

Another aspect for the invention is a method for connecting the real estate related professionals to parties undergoing real estate transaction is also disclosed, comprising of: receiving and storing in a database, information from real estate related professionals comprising of: identification of professional, service provided, and location; receiving and storing data from perspective clients in a database, comprising of sellers, buyer, tenants and landlord; analysing data input from real estate related professionals and perspective clients and presenting real estate related professionals to perspective clients; providing means for communication between real estate related professionals and perspective clients. In one embodiment, the method also comprises of using a draft standard agreement, to allow the real estate related professional and user to enter into a contract.

In another embodiment, the method may further comprise of confirming the standard of the service provided by real estate related professional by contacting a third party for a review. In a final embodiment, the method may include providing financial status of the client to real estate related professional, and connecting the client with real estate related professional is dependent on the financial status of client.

### BRIEF DESCRIPTION OF THE DRAWINGS

FIG. 1 illustrates a potential environment in which the disclosed invention may be used.

FIG. 2 illustrates an example of a seller using one disclosed method to sell a property.

FIG. 3 illustrates an example of a tenant using one disclosed method to lease a property.

FIG. 4 illustrates an example of using another aspect of the disclosed invention to connect a service provider with a client.

FIG. 5 is a flowchart showing a method for conducting peer to peer real estate transactions.

FIG. 6 is an example showing a system for conducting peer to peer real estate transactions.

FIG. 7 is a flowchart showing a method for connecting a real estate related professional to a client.

### DETAILED DESCRIPTION OF THE INVENTION

The present disclosure herein provides a method and system in which real estate transactions can be performed in a purely peer to peer manner. The disclosed invention excludes the need for real estate brokers or agents to participate in the transaction as an intermediator. The system and method provides sellers, buyers, renters, landlords, and real estate related service providers, comprising of: legal representatives, contractors, decorators amongst others, to communicate with one another and potentially enter into agreements and contracts.

The invention may be a web browser based interface, or a mobile based application that allows for the transmittance of data to a server, which analyses the data and returns recommendations based on the needs set forth in the data transmitted. The data transmitted and stored may include: seller's personal data, property data, buyer's personal data, landlord's personal data, renter's personal data, and service provider's professional data. The data may be transmitted through the use of a local area network (LAN), wide area network (WAN), any intranet system, or through the Internet to a memory storage unit forming a database of the information input to the system.

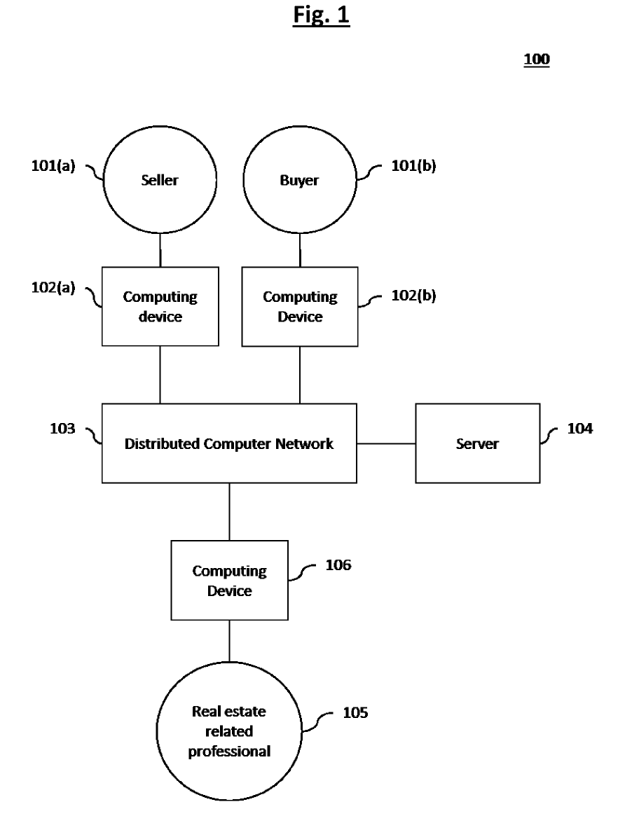

Referring to FIG. 1, an illustrative example of an environment 100 in which the method and system can be implemented. The environment may include multiple users acting in a number of different capacities all wishing to conduct real estate transactions. In one embodiment, users may include, but is not limited to: residential real estate sellers, residential real estate buyers, commercial real estate sellers, commercial real estate buyers, residential real estate landlords, residential real estate tenants, commercial property managers, commercial property lessees. For ease of understanding, example environment 100, illustrates a single seller 101(a) and a single buyer 101(b) as the users of one aspect of the invention. The two users input data into processing units 102(a) and 102(b) for the seller and buyer, respectively. The processing units can be any manner of computing device that comprises a processor, a memory, and a means to transmit data through a network. In one embodiment, the computing device may be a personal computer or laptop. In another embodiment, the computing device may consist of mobile devices, including: smart cellular phones, tablets and smart watches.

An interface may be used to prompt users 101(a) and 101(b) to transmit information from computing unit through a distributed computer network 103 to a server 104. In one embodiment, the interface provided is in the form of a webpage accessed from a remotely located server, through a browser. In another embodiment, the interface is in the form of a locally accessed software application, stored in the memory of the computing unit. The user may be prompted by either interface to create an account, that requires a flat fee. The account may store information that comprised of: seller data, buyer data, vendor data, contact information, financial data, property information, or any combination thereof. The system may further require users to create a profile, that is displayed to other users of the system. An account must be made to provide access of users 101(a) and 101(b) to server 104 via the distributed computer network 103. The distributed computer network 103 may comprise of multiple computing devices connected through any system including a LAN, WAN, intranet system or through the internet.

In environment 100, only a single server is illustrated, however, multiple servers may be used for storage and processing needs. Real estate related professionals 105 comprising of legal service providers, escrow service providers, interior designers, contractors, architects, moving companies, furniture providers, and property managers, may also input data to be stored in the memory of server 104. The data is communicated to the server using a computing device 106 via the computer network 103. In one embodiment, the interface for input of a service provider data may be in the form of a website. In another embodiment in the form of a locally accessed software application, stored in the memory of the computing unit. The interface used by real estate related professionals 105 may take a different from to that provided to users 101(a) and 101(b).

A database of all input information from potential clients 101(a), 101(b) and real estate related professionals 105 may be stored on server 104 (or multiple servers as the case may be). There may be at least three distinct databases, containing offer data, buyer data and real estate related data. Server 104 may additionally have a set of programmed instructions to extract key information into the data deposited by users 101(a), 101(b), and 105 in the database.

Limited access to each database may be provided by the server, dependent on where the query originates. If the query is from a buyer 101(b), only information submitted by a seller 101(a) or service provider 105 is provided. If the query is from a seller 101(a), only buyer 101(b) or service provider 105 information is provided. Queries to the database from a service provider may not be answered unless permission from either seller 101(a) or buyer 101(b) is first obtained. The server may also contain instructions to analyse data to match perspective parties based on information extracted from input data. In one embodiment, matches may be limited using location as the primary parameter, followed by price.

The server may also contain further instructions to facilitate communication between any parties wishing to engage in dialogue for example 101(a) with 101(b), 101(a) with 105 or 101(b) with 105 through the computer network 103. The method of communication, in one embodiment may be through instant messaging services between two direct parties such as 101(a) with 101(b). In another embodiment, the method of communication may be through an online forum setting where a single user is able to communicate with multiple other users simultaneously, where all users have accounts and profiles set up with the system.

The server may also be configured to contact third parties upon receiving instructions from users 101(a) or 101(b). Third parties may include any party that is not in any database on server 104, for example a credit bureau, a former landlord or external mortgage brokers. The server may equally be configured to contact third parties upon receiving data from user 105, which may include previous clients.

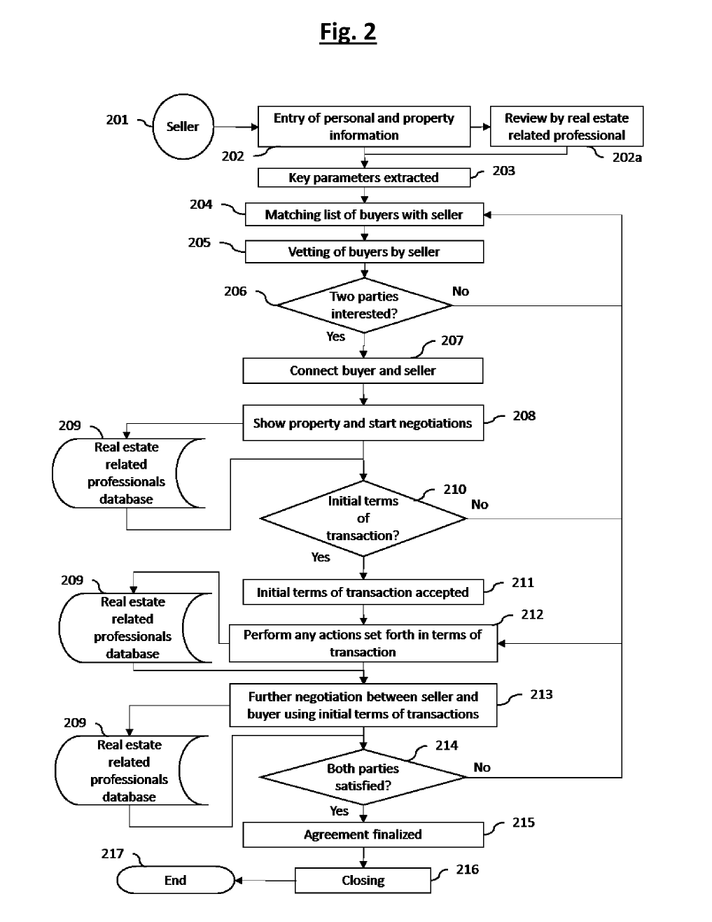

Referring to FIG. 2, which illustrates a flow diagram of a potential exchange between a seller 201 engaging in a real estate transaction using one aspect of the disclosed invention in the form of a web site. Firstly, the user accesses a web site interface, and may be presented with a number of links representing different types of transactions, for example, buy, rent sell, mortgages, foreclosure/short sale and additional services. Selecting the ‘Sell’ link will send the user to a separate page in which a description of the advantages of using the disclosed invention over traditional broker based systems.

The option to list a property may then be presented, which when selected would prompt the seller to sign up for an account 202. Account set up may be achieved through input of account information, banking information, and the payment of a flat fee. Account information may include a name, address, phone number, and email address along with a password. Banking information, including credit card information, debit card information, or bank account information, may also be required to facilitate the payment of the required fee.

The system may then prompt the entry of further information regarding the real estate property the seller 201 wishes to place onto the market. Property information requested may include: address; type of property; photographs of the property; square footage of property; amenities provided by property; type of climate control; building type; number of rooms; security measures owned by the property; type of parking offered; proximity of schools in the area; and types of entertainment in close proximity to property. The system may prompt the seller 201 to create a profile for the property, that is displayed to potential buyers, comprised of the aforementioned property information.

The seller 201 may be provided with the option to have the information reviewed by a real estate related professional 202a which may include photographers and interior designers, to ensure the property is well presented in the property profile. If the user declines to use the suggested real estate related professionals in 202a, the user will be prompted by the interface to upload pictures of the property. Additionally, the seller 201 may be prompted to upload a short video displaying the property to any perspective buyers. In the case that seller 201 does not use a real estate related professional 202a, media uploaded by user may be reviewed and approved by the system. In one embodiment, the approval is performed in an automated manner, through an actionable set of commands stored on a server. In another embodiment, the approval is performed manually, through access to the server by a reviewer. The review and approval in the preferred embodiment will take 24 hours to achieve. Photographs and videos only serve as examples of the media that a seller may be urged to upload, and any other type of visual or audio media may be uploaded. The requested property information and photographs are transmitted and stored on a remote server in an accessible database.

The server has an actionable program 203 through which key parameters including: geographical location of property; type of property; square footage of property; amenities provided by property; type of climate control; building type; number of rooms; security measures owned by the property; type of parking offered; proximity of schools in the area; and types of entertainment in close proximity to property, are extracted from the input data. The extracted data may then be used to present listed property to any enquiries into properties with matching parameters 204. The server may be programmed to rank properties by location, followed by price when presenting a list as the result of an enquiry submitted by a buyer. In one embodiment, the seller 201 is able to list their property as a ‘Featured Home’, which requires an additional fee. The server may be programmed to move any Featured Homes, to the top of any list compiled.

If a buyer is interested in the listed property by seller 201, information regarding the buyer is presented to the seller. The information presented to the seller 201 may be the profile of the buyer, which may comprise: contact details and financial information. In the preferred embodiment, the seller is presented with a profile comprising of the name, email address, and credit score of each interested buyer. The buyer may be presented with an option to send the property profile to a third party, such as a friend or another party interested in purchasing a property. If the third party does not already have an existing account, they may be prompted to sign up to an account to access the contact information of the seller.

Upon presentation of the profiles of the interested parties to the property, the seller 201 may then decide if they are interested in any parties presented 206. If the seller 201 is interested in a buyer, the two parties are connected by providing both parties with the seller and buyer profiles. The seller 201 is able to select multiple buyers to engage with. If the seller is not interested in the buyer, they are able to reject the buyer or ignore the buyer. If the seller is not interested in any presented buyers, the seller is able to return to process 204, which will present any new interested parties. Additionally, a time limit on decision 206 may be applied, on the action of the buyer or seller, after which the offer to connect is considered to be rejected.

The seller 201 and buyer may be connected 207, in one embodiment through an email system. Whilst, in another embodiment, the method of contact is through direct messaging. In a further embodiment, the method of contact is through telephone. During the first contact between a seller and buyer, the two parties may set up a date and time to view the property 208. The decision for a time and date to view the property in one embodiment may be facilitated though the use of a calendar scheduling service provided through the interface. The number of visits a property gains may be stored in the system and displayed to potential buyers through the profile of the property.

Before, during or after the viewing of the property 208, the seller 201 has an option to access a database containing real estate related professionals 209. The database may include: information regarding the type of service the real estate professional provides, reviews on the performance of the service provided, quality of service provider, an indication on the cost of a service provider and contact information on the service provider. The database 209 may provide contact information to services in preparing for a viewing, including interior designers and photographers to the seller. Before, during or following the viewing of the property by the buyer, the seller may receive an initial offer price for the property. This price may be negotiated by both seller and buyer at any time before an initial terms of transaction is set in process 211.

The negotiations may also include other terms such as specific requirements from either buyer or seller 201. For example, a seller may require proof of funds or a pre-qualification letter to further negotiations. A buyer, may for example require a home inspection or any other structural work to be carried out first prior to advancing negotiations. As such the seller and buyer may continue negotiating until a both parties are sufficiently satisfied 210.

If a preliminary terms of transaction is not reached and a party does not wish to continue, the seller and buyer may be directed back to process 204. Any negotiations performed through a traceable medium, such as messenger or email may be stored, in the database associated with the buyer and seller, and may be accessed any time by either party. If a preliminary terms of transaction is reached 211, these terms are set and both parties must complete the required tasks to advance negotiations 212. Upon acceptance of the initial terms of the transaction 211, the property may be removed from the database of property listings. A time limit on performing these set of actions may be set by either seller 201 or buyer, after which if the actions have not been satisfactorily achieved, the negotiations may be cancelled.

The seller is able to access and hire the real estate related professionals stored in database 209, to fulfil any requirements set forth in the initial terms of transaction. The real estate related professionals may include: contractors, home inspectors and attorneys. In one embodiment, the buyer or seller may request a specific real estate related professional from the database 209, to be used as a part of the initial terms of transaction. In an alternate embodiment, an external real estate related professional (one not found in database 209) may be designated to perform the work set forth in the initial terms of transaction, provided that both parties agree to an external service provider being used to conduct the work.

Upon fulfilling the requirements of the initial terms of transaction, the buyer or seller may deposit the information into their accounts through the webpage interface. The results of the actions may be reviewed by the other party and further negotiations 213 may take place. For example, if the home inspection requested by the buyer, shows that there are deficiencies that must be fixed, the buyer may then request that the seller 201 fix the identified issues before further negotiations are held. The seller 201 may decide to fix the issues, offer a reduction in the price, offer a warranty for work on the house, or any other option. This negotiation 213 may lead to further actions being required, as in the provided example, and as such would lead back to process 212. The database 209 may be used to identify and hire a real estate related professional to carry out any required work (e.g an attorney to draft or review an agreement between the parties). The process may loop between 212 and 213 until both parties are satisfied leading to a refined terms of transaction being set 215, or one party withdraws from negotiations, leading the process to return to 204.

During process 213, a legal representative may be chosen from database 209 to review and draw up a legally binding contract for the transfer of the deed from seller to buyer. Additionally, a holding company or escrow company may be selected from database 209 to conduct the closing of the sale. Once both parties meet the requirements of the contract, the deed is transferred and the transaction is complete 217.

The process described in FIG. 2 refers to the traditional sale of a property, however, the process may also be used for foreclosures or short-sales. The buyer in this case may be the owner of the system and the seller may be able to directly contact a representative for the sale of the property. The sale of the property would follow the same steps as above, but in an expedited manner.

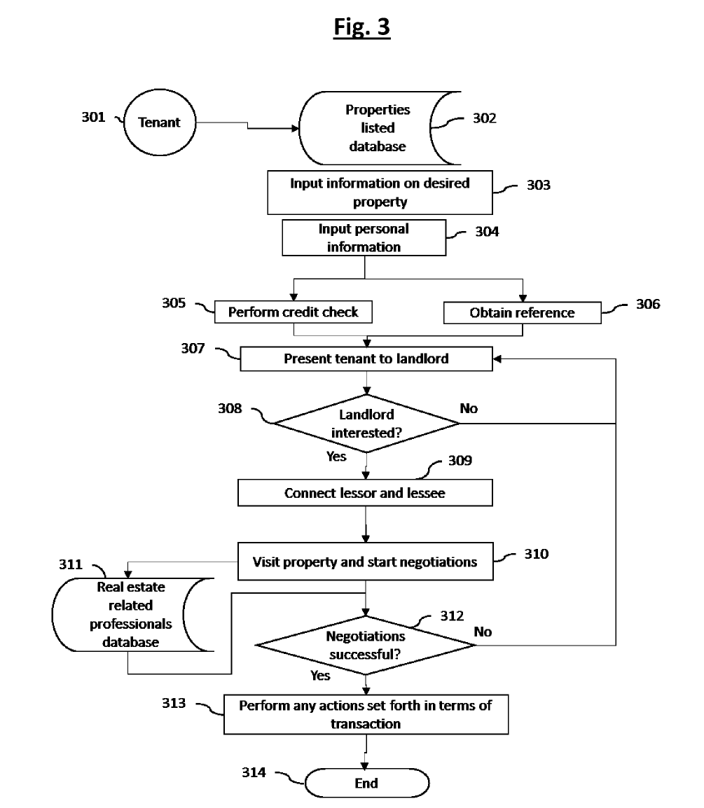

Referring now to FIG. 3, which illustrates a tenant 301 using the process to lease a property in the form of a website. A perspective tenant 301 is able to access a server to search a database with property data entered by both sellers and landlords 302. The tenant 301 may input information on a desired property 303 and filter the results using a number of different parameters, which include: type of transaction, location of property, type of property, square footage of property, amenities provided by property, type of climate control, building type, number of rooms, security measures owned by the property, type of parking offered, proximity of schools in the area, and types of entertainment in close proximity to property. In one embodiment, the server will first limit the number of results from the database by location and rank the results based first on price, followed by number of rooms, and then all subsequent filters. In a further embodiment, the server will display ‘Featured Properties’ at the top of a list. In one embodiment, the list provided to the tenant will comprise of: a photograph, a brief description of the property, a town or district the property is located and the monthly rent.

In another embodiment, the properties matching the filtered results is displayed in the form of an interactive map that shows the location of a property, with an option to link to a webpage with further information on a property. The displayed interactive map may be configured to provide information on services in the local area displayed. The services that are displayed may include: doctors, schools, airports, hospitals, automatic teller machines, banks, churches, shopping malls, public transit, and movie theatres. In a further embodiment, the tenant 301, is able to search for properties for lease by entering a zip code. The entry of the zip code will display an interactive map in which the boundaries of the zip code is defined and available properties are highlighted.

If the tenant 301 is interested in a particular property, the tenant may first be prompted to input personal information and set up an account for a fixed fee 304. Account information and banking information may be required to set up an account. Account information may include a name, address, phone number, and email address along with a password. Banking information, including credit card information, debit card information, or bank account information, may also be required to facilitate the payment of the required fee.

The tenant 301 may be prompted to input further information 304 to finish activation of the account. In one embodiment, the interface may not allow the tenant to contact a landlord until a profile containing further information is entered and stored in the database. Information that may be requested may include: the date of birth of tenant, social security number of tenant, contact information of previous landlord and a reference from the previous landlord, if applicable. In another embodiment, in which the tenant is a commercial entity, the information that may be requested may include: name of business, information of executives, number of employees and financial data of the business.

In one embodiment, the interface may provide an option for a tenant to request a credit check from a third party credit bureau 305. The server may be configured upon consent of the tenant 301 to contact a server, which may or may not be the same server, for credit information regarding tenant. The interface may display that information to the tenant 301 and may further provide an option to store the credit score on the database with the tenant's personal information. The tenant 301 may be able to access the credit report by logging into the account in the future. The tenant 301 may also be able to present the credit report when applying to view a property, or requesting the use of a service provider.

In one embodiment, the interface may ask if the tenant 301, has had a previous landlord. If the tenant 301 answers affirmative, then the server may be configured upon consent of the tenant to contact a previous landlord for a character reference of the tenant 306. The contact may in the form of an email and may contain a draft landlord reference letter comprising of: the name of the tenants, the address of the property, the time spent at the property, a statement regarding the tenants stay at the previous property, contact details of the landlord. The landlord may then assent to the use of the reference letter or may edit the reference letter as appropriate and return an email with the reference letter. The server may then store the reference letter from the landlord in the database with the tenant's personal information. In another embodiment, the tenant 301 may directly upload a copy of the reference letter from their previous landlord.

The tenant 301 may be provided with contact information for the landlord through the landlord's profile. In one embodiment, the contact information may include: email address, phone number and address. In another embodiment, the contact with the landlord may be through an instant messaging service between the tenant and landlord accounts, accessed through the interface. The tenant may send further information to the landlord including: contact information, a credit report and a reference from a previous landlord. The tenant 301 may also include a message along with the information to the landlord containing any other information the tenant 301 may decide to include.

Upon furnishing the contact information and information regarding the rental history of the tenant 301, the landlord is free to make a decision 308 on whether to further contact with the tenant 301. The landlord may decide against maintaining further contact with the tenant 301, upon reviewing the information provided. At this point, the tenant can return to the properties listed database 302 to find another property. A time limit may be set by either the landlord or tenant after which if no reply is received from either party, contact between tenant and landlord is terminated automatically and the tenant 301 is returned to database 302. Alternately, the landlord may maintain contact with the tenant, by arranging a viewing of the property. The scheduling of the viewing of the property, in one embodiment, may be facilitated though the use of a calendar scheduling service provided through the interface.

Negotiations may occur during the meeting to show the property and finalized during through entry into the database. Pricing for the property may be discussed before, during or following the showing of the apartment, and may be negotiated. Both parties may add requirements to be fulfilled prior to agreement. The negotiation may be accepted before, during or following the showing of the property to the tenant 301. A time limit may be set by either party to which a decision must be made 312, after which the negotiations may be terminated, returning the tenant back to process 304. Any negotiations performed through a traceable medium, such as messenger or email may be stored in the database and may be accessed by either party at any time.

Both parties will be available to access the real estate related professionals database 311 through the website before, during or following negotiations. Services provided by the real estate related professionals may be employed, for example, to resolve any issues the tenant may find with the property 313, and as such the professionals may include, contractors and interior designers. Legal representation may also be available to draft or review any lease agreement that may be presented during negotiations. Financial services may also be offered, including escrow services may also be provided by the real estate related professional, to hold the security deposit. The process will finish upon signing of the lease agreement and the transfer of the keys 314.

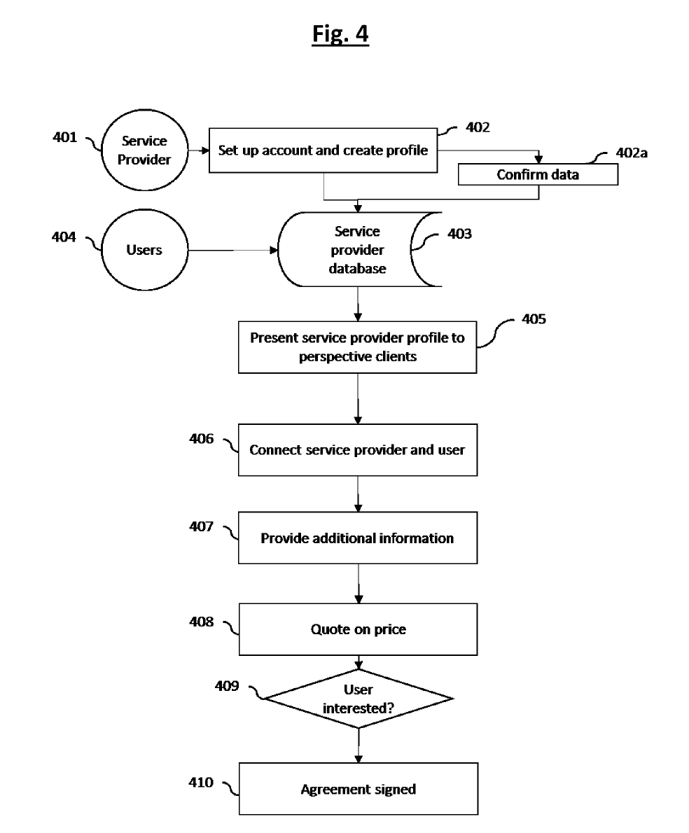

Referring to FIG. 4 another aspect of the current disclosure is displayed as a flow diagram, and is directed to a method of connecting a real estate related professional with a potential client. A database comprising of information regarding a number of different service providers 403 can be compiled. To be entered into the database, the service provider or vendor 401 must create an account and profile for a flat fee 402. Information stored, associated with the account may include: name of business, service provided, cost range, previous assignments, photographs of previous work, business web addresses, credentials and standard service agreements. The service provider may be able to customize their profile that is displayed to potential clients, by deciding what stored information to display and the format in which the information is displayed. The server may be instructed by an administrator to contact third parties to confirm information provided by the service provider or to obtain further information regarding the service provider 402a. Third parties may be asked for information regarding the standard of service provided, photographs of previous work and reviews of the service provider. This all acts to ensure the real estate related professional is vetted prior to presenting the service provider to any potential clients.

Users comprising of sellers, buyers, landlords, tenants, or other service providers 404 may access the database of real estate related professionals 403 through an interface at any time during a real estate related transaction. In one embodiment, the user interface is in the form of a webpage. In another embodiment, the user interface is in the form of an application. The user may enter information, which may include: service required, location, price range, into a server. The server may return a list or results 405, which in one embodiment, is a list of matching service providers and is ranked by location. In another embodiment, the matching service providers are presented in the form of an interactive map with the matching service providers' locations highlighted.

If the user 404 selects a service provider, the user is provided with means to communicate with the real estate related professional 406, which may include: providing an email address, providing a telephone number, providing access to a webpage based instant messenger, or providing access to a software application based instant messenger. The user may communicate directly with the service provider to negotiate work to be done. The user may also use the means of communication provided to transmit property information directly to the service provider 407. The property information may thus be used by the service provider to provide an estimate of the cost of work to be done 408. Scheduling of an in person meeting may also be achieved through the means for communication. In one embodiment, scheduling is facilitated though the use of a calendar scheduling service provided through the interface.

Following negotiations, the user may decide on using the real estate related professional for the services 409. If negotiations are successful, the service provider may send a service agreement to the user. The agreement may be sent using an email, mail, or through the interface provided, or alternatively be presented to the client during an in person meeting 410. If negotiations are unsuccessful, the user may once again access the database and find another service provider.

One further embodiment of the disclosed method is the ability for the service provider to equally screen potential clients. This allows a service provider to save time by not meeting with potential clients that may be untrustworthy. The service provider may request access to a potential client's credit report to determine the client's financial status 407. With the consent of the client for the service provider to access the financial status of the client, the credit report may be transmitted to the service provider. The screening step may be used to ensure the client is able to obtain sufficient funding to pay for work done, which is especially important in larger more expensive projects. The screening can be performed before, during or after an in person meeting.

Apart from screening, the credit report of a potential client may also be used for services. For example, mortgage brokers, use the credit report extensively, to determine the terms of a mortgage. The system disclosed may be able to disseminate the credit report of a potential client to a multitude of different mortgage brokers, chosen by the potential client simultaneously, providing the user with an easy method to obtain multiple quotes.

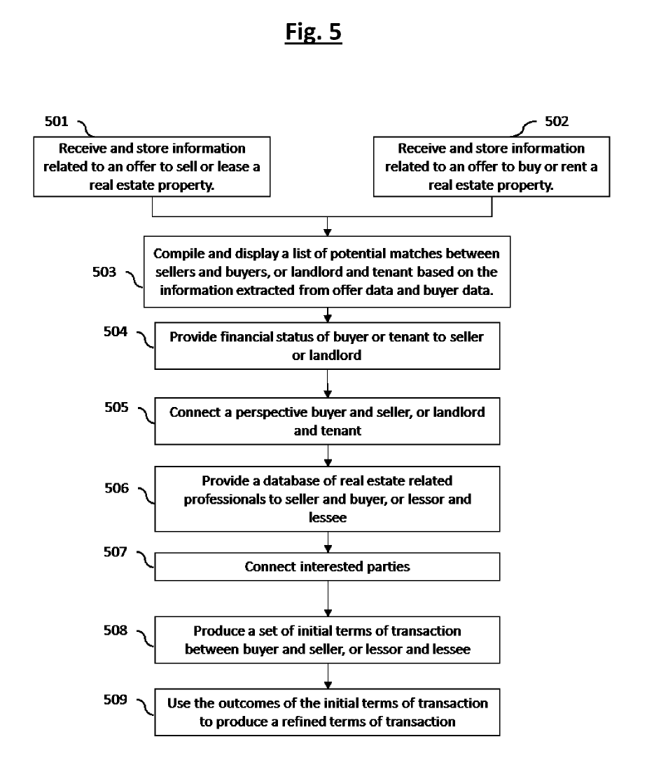

Referring to FIG. 5, a flow diagram demonstrating the generalized steps of the disclosure for performing a peer to peer real estate transaction. Data comprised of information related to an offer to sell or lease a real estate property is stored, once the seller or landlord has successfully created an account 501. Data comprised of information related to an interest in buying or renting a real estate property is stored 502. A list comprising of potential matches between sellers and buyers, or lessors and lessees based on the information extracted from offer data and buyer data is compiled 503. Buyer or tenants are able to select and contact sellers or landlords upon setting up an account in the system. Buyers or tenants may be required to provide financial data to the seller or landlord 504. The system then connects a perspective buyer and seller, or lessor and lessee 505. During the process, a database of real estate related professionals is provided to seller and buyer, or lessor and lessee 506. If any user is interested in the use of the service providers in the database, the system connects the interested parties 507.

In certain embodiments, third parties may be contacted to confirm the input data from the seller, buyer, tenant or landlord. This information may include the financial status of the buyer or tenant. In a further embodiment, the connection of a buyer and seller, or tenant and landlord is contingent on the buyer or tenant meeting a certain financial threshold set by the buyer. In another embodiment, negotiations between the seller and buyer, or tenant and landlord are conducted by a real estate related professionals from said database.

In certain embodiments, the method may also comprise of producing a set of initial terms of transaction between buyer and seller, or lessor and lessee 508. The initial terms of transactions may require specific functions to be completed, and in one embodiment, the terms of the initial terms of transaction is completed using a real estate related professional from provided database. In a further embodiment, the method may additionally comprise of using the outcomes of the initial terms of transaction to produce a refined terms of transaction 509. In yet another embodiment, a legal professional from the database of real estate related professionals is used to produce a binding contract between seller and buyer, or lessor and lessee, based on the refined terms of transaction.

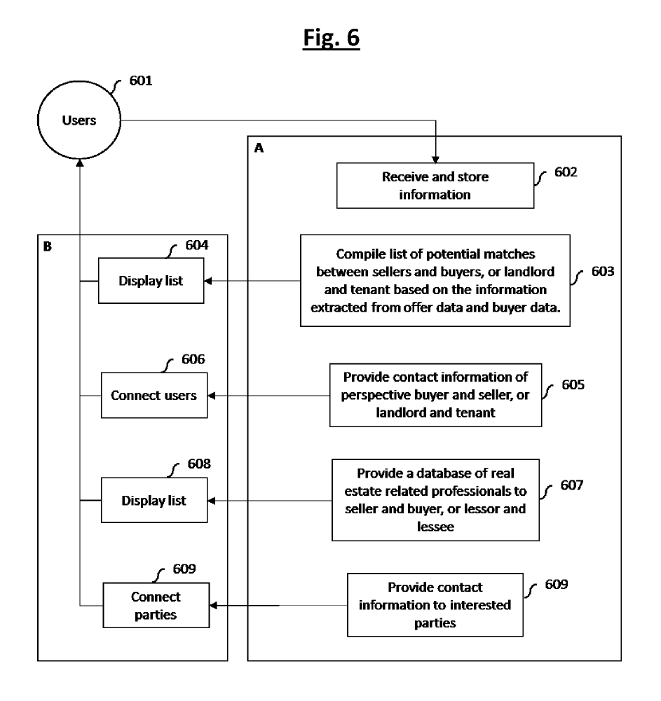

Referring to FIG. 6 which is an example of a system to perform a peer to peer transaction. The system contains two portions, one which comprises of a processor and memory unit A that is configured to: receive and store receive and store data 602, wherein the data is comprised of information related to an offer to sell or lease a real estate property from a user 601; compile a list comprising of potential matches between sellers and buyers, or lessors and lessees based on the information extracted from offer data and buyer data 603; provide contact information of a perspective seller, buyer, lessor or lessee 605; provide access to a database of real estate related professionals 607; and provide contact information of any interested parties 609. The computing unit A is able to transfer the data to a separate computing unit B that is able to display data including list of potential matches between sellers and buyers, or landlord and tenants 604, and list of real estate related professionals 608. Computing unit B may also provide the means for connecting parties such as a buyer and seller, or landlord and tenant 605, or interested parties 609.

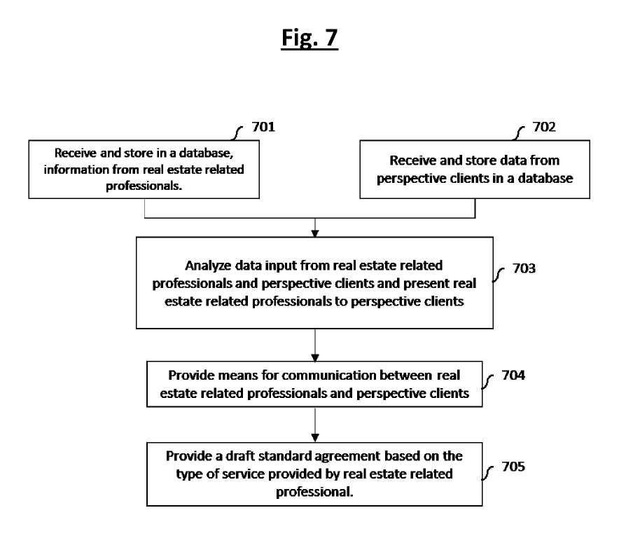

Finally, referring to FIG. 7, a generalized flow diagram for connecting real estate related professionals to parties undergoing real estate transactions. Information from real estate related professionals comprising of: identification of professional, service provided, and location is received and stored in a database 701. Data from perspective clients, comprised of sellers, buyer, tenants and landlords is received and stored in a database 702. Data input from real estate related professionals and perspective clients is analysed and real estate related professionals are presented to perspective clients 703. A means for communication between real estate related professionals and perspective clients is provided 704. The method may further comprise of providing a draft standard agreement based on the type of service provided by real estate related professional 705. In one embodiment, the standard of the service provided by real estate related professional is confirmed by contacting a third party. In another embodiment, the financial status of the client is provided to the real estate related professional and connection of the client with real estate related professional is dependent on the financial status of client.

The above are exemplary embodiments of users going through the disclosed method. However, the disclosed system and method may be used by any number of different users, including not only sellers and tenants, but also buyers and landlords. The process for a landlord may be more similar to that undergone by a seller, whilst the process for a buyer may be more similar to a tenant. The examples provided are in a residential context, but the invention may be equally applied to a sale of commercial property or to the lease of a commercial property. The individual steps followed by each user may be modified or change, but one skilled in the art will be able to appreciate the underlying scope and spirit of the invention.

What is claimed is:

1. A method for performing real estate transactions in a peer to peer manner over a distributed computing network comprising the steps of:
a. receiving and storing data, wherein the data is comprised of information related to an offer to sell or lease a real estate property;
b. receiving and storing data, wherein the data is comprised of information related to an interest in buying or renting a real estate property;
c. compiling a list comprising of potential matches between sellers and buyers, or lessors and lessees based on the information extracted from offer data and buyer data;
d. connecting a perspective buyer and seller, or lessor and lessee;
e. providing a database of real estate related professionals to seller and buyer, or lessor and lessee; and
f. connecting the interested parties.

2. The method of claim 1, further comprising contacting third parties to confirm accuracy of data input from seller, buyer, tenant, or landlord.

3. The method of claim 1, further comprising of contacting third parties to confirm financial status of buyer or tenant.

4. The method of claim 3, wherein the connecting of a buyer and seller, or lessor and lessee is based upon the financial status of a buyer or tenant.

5. The method of claim 1, further comprising negotiations conducted by a real estate related professional from said database.

6. The method of claim 1, further comprising: producing a set of initial terms of transaction between buyer and seller, or lessor and lessee.

7. The method of claim 6, further comprising: fulfilling terms of the initial terms of transaction using a real estate related professional from said database.

8. The method of claim 7, further comprising of using the outcomes of the initial terms of transaction to produce a refined terms of transaction.

9. The method of claim 8, wherein a legal professional from the database of real estate related professionals is used to produce a binding contract between seller and buyer, or lessor and lessee.

10. A system for performing real estate transactions in a peer to peer manner over a distributed computing network comprising a processor and memory unit that is configured to:
a. receive and store data, wherein the data is comprised of information related to an offer to sell or lease a real estate property;
b. receive and store data, wherein the data is comprised of information related to an interest in buying or renting a real estate property;
c. compile a list comprising of potential matches between sellers and buyers, or lessors and lessees based on the information extracted from offer data and buyer data; and
d. connects a perspective seller and buyer, or lessor and lessee;
e. provides access to a database of real estate related professionals; and
f. connects any interested parties.

11. The system of claim 10, wherein the computing device is further configured to contact a third party to confirm data input from seller, buyer, lessor or lessee.

12. The system of claim 10, wherein the financial information from buyer or lessee is requested and confirmed.

13. The system of claim 12, wherein the computing device is further configured to store a set of terms of transaction between a seller and buyer, or lessor and lessee; and able to transmit the terms of transaction to respective parties.

14. The system of claim 12, wherein the computing device is further configured to only connects two parties if a financial standard is met.

15. The system of claim 13, wherein the computing device is further configured to store and make available records of services provided by said real estate related professionals.

16. A method for connecting real estate related professionals to parties undergoing real estate transactions comprising of:
a. receiving and storing in a database, information from real estate related professionals comprising of: identification of professional, service provided, and location;
b. receiving and storing data from perspective clients in a database, comprising of sellers, buyer, tenants and landlord;
c. analysing data input from real estate related professionals and perspective clients and presenting real estate related professionals to perspective clients; and
d. providing means for communication between real estate related professionals and perspective clients;

17. The method of claim 16, which further comprises of providing a draft standard agreement based on the type of service provided by real estate related professional.

18. The method of claim 16, which further comprises of confirming the standard of the service provided by real estate related professional by contacting a third party.

19. The method of claim 16, which further comprises of: providing financial status of the client to real estate related professional and connecting client with real estate related professional is dependent on the financial status of client.
